(19) United States
(12) Patent Application Publication
(10) Pub. No.: US 2014/0057170 A1
(43) Pub. Date: Feb. 27, 2014

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Jun-Kyu Cha, Yongin-si (KR); Myoung-Sun Kim, Yongin-si (KR); Young-su Kim, Yongin-si (KR); Ki-Jun Kim, Yongin-si (KR)

(73) Assignee: Samsung SDI Co., Ltd., Yongin-si (KR)

(21) Appl. No.: 13/827,148

(22) Filed: Mar. 14, 2013

(30) Foreign Application Priority Data
Aug. 23, 2012 (KR) 10-2012-0092565

(51) Int. Cl. H01M 4/134; H01M 4/66; H01M 4/136; H01M 4/62

(52) U.S. Cl. CPC H01M 4/134; H01M 4/622; H01M 4/663; H01M 4/136
USPC 429/217; 429/209; 429/245; 429/231.5; 429/231.6; 429/231.95; 429/231.8; 429/225

(57) ABSTRACT

A negative electrode for a rechargeable lithium battery includes an active material layer including a non-carbon-based negative active material, and a first binder having high-strength; a conductive layer including a conductive material and a second binder; and a current collector. The conductive layer is interposed between the active material layer and the current collector.

### CLAIM OF PRIORITY

This application makes reference to, incorporates the same herein, and claims all benefits accruing under 35 U.S.C. §119 from an application earlier filed in the Korean Intellectual Property Office on Aug. 23, 2012 and there duly assigned Serial No. 10-2012-0092565.

### BACKGROUND OF THE INVENTION

1. Field of Invention

Embodiments of the present invention generally relate to a negative electrode for a rechargeable lithium battery and a rechargeable lithium battery including the same, and more particularly, to a negative electrode for a rechargeable lithium battery that may improve cycle-life and alleviate wrinkle problem, and to a rechargeable lithium battery including the same.

2. Description of the Related Art

Batteries transform chemical energy generated from electrochemical redox reaction of a chemical material into electrical energy. Such batteries are divided into primary batteries, which should be discarded after consuming all the energy, and rechargeable batteries, which can be recharged many times. The rechargeable batteries can be charged/discharged many times based on the reversible transformation between chemical energy and electrical energy.

Recent development in the high-tech electronic industry has allowed an electronic device to become smaller and lighter in weight, which leads to more uses of a portable electronic device. The portable electronic device increasingly requires a battery with high energy density as a power source. Accordingly, research on a lithium rechargeable battery is briskly under progress.

### SUMMARY OF THE INVENTION

One embodiment of the present invention provides a negative electrode for a rechargeable battery having improved cycle-life characteristic but no current collector transformation using a high-strength polymer and a rechargeable lithium battery including the negative electrode.

According to one embodiment of the present invention, provided is a negative electrode for a rechargeable lithium battery that includes an active material layer including a non-carbon-based negative active material, and a first binder having high-strength; a conductive layer including a conductive material and a second binder; and a current collector. The conductive layer is interposed between the active material layer and current collector.

The first binder having high-strength may be at least one selected from polyimide, polyamideimide, polysulfone, polyphenylenesulfide, polyetherimide, polyethersulfone, polyarylate, polyetheretherketone, modified polyimide and a combination thereof.

The second binder may be selected from polyvinylalcohol, polyacrylic acid, poly acrylamide, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and a combination thereof.

The conductive material may be selected from a carbon-based material, a metal-based material, a conductive polymer, and a combination thereof.

The conductive material may be a carbon-based material being incapable of intercalating and deintercalating lithium.

The conductive material may be a carbon-based material being capable of intercalating and deintercalating lithium.

The non-carbon-based negative active material may be selected from a lithium metal, a lithium metal alloy, Si, SiOₓ (0<x<2), a Si—C composite, a Si-Q alloy (wherein Q is an element selected from an alkali metal, an alkaline-earth metal, Group 13 to 16 elements, a transition element, a rare earth element, or a combination thereof, but is not Si), Sn, SnO₂, a Sn—C composite, a Sn—R alloy (wherein R is an alkali metal, an alkaline-earth metal, Group 13 to 16 elements, a transition element, a rare earth element, or a combination thereof, but not Sn), a transition element oxide, and a combination thereof.

The non-carbon-based negative active material may include at least about 20 wt % of a Si atom based on the total weight of a negative active material.

The active material layer may further include a carbon-based negative active material as well as the non-carbon-based negative active material.

The conductive material may be included as a first conductive material, and the active material layer may further include a second conductive material.

The second conductive material may be selected from a carbon-based material, a metal-based material, a conductive polymer, and a combination thereof.

According to another embodiment of the present invention, provided is a rechargeable lithium battery that includes the negative electrode for a rechargeable lithium battery; a positive electrode including a positive active material; and an electrolyte.

Accordingly, the present invention may improve transformation of a negative electrode. And thus, cycle-life deterioration, safety problem, and the like of a rechargeable lithium battery including the negative electrode may be alleviated.

### BRIEF DESCRIPTION OF THE DRAWINGS

FIG. 1 is an exploded oblique view of a rechargeable lithium battery constructed as an embodiment of the present invention;

FIG. 2 is a diagram showing cycle-life characteristic of a rechargeable lithium battery cells according to Examples 1 to 2;

FIG. 3 is a diagram showing cycle-life characteristic of a rechargeable lithium battery cells according to Comparative Examples 1, 2, 3 and 5;

FIG. 4 is a photograph of a copper current collector after first charge of the rechargeable lithium battery cell according to Example 1;

FIG. 5 is a photograph of a copper current collector after first charge of the rechargeable lithium battery cell according to Example 2;

FIG. 6 is a photograph of a copper current collector after first charge of the rechargeable lithium battery cell according to Comparative Example 1; and

FIG. 7 is a photograph of a copper current collector after first charge of the rechargeable lithium battery according to Comparative Example 4.

### DETAILED DESCRIPTION OF THE INVENTION

An exemplary embodiment of this disclosure will hereinafter be described in detail. However, the embodiment is only exemplary, and this disclosure is not limited thereto.

In general, a negative electrode for a rechargeable lithium battery is fabricated by mixing an electrode active material, a binder, and a conductive agent to prepare slurry, coating the slurry on a current collector, and then, drying and compressing the coated current collector. The binder commonly includes polyvinylidene fluoride or styrene-butadiene rubber.

A graphite-based active material has been used as a negative active material for a rechargeable lithium battery but reaches a limit to increased capacity since its capacity per gram is 372 mAh/g. Accordingly, a non-carbon-based active material able to attain a capacity of greater than or equal to 600 mAh/g such as Si, Sn, or the like is being actively sought. These non-carbon-based active materials react with lithium (intercalate lithium ions) however, and have a volume expansion close to about 400% at most. This physical change may cause a short circuit to a conductive path in an electrode and seriously deteriorate cycle-life characteristics of a rechargeable lithium battery. The non-carbon-based active materials generally refers to a metal-based active material. As used herein, the term “metal” refers to a material having good thermo- or electric-conductivity, and non-limiting examples thereof include a general metal such as alkali metal and semi-metal having semi-conductivity such as Si.

There have been disclosed many patents of using a high-strength polymer having a high tensile strength such as polyamideimide or polyimide as a binder in order to suppress the volume expansion of a non-carbon-based active material. The high-strength polymer having high tensile strength suppresses the volume expansion of the active material and may remarkably increase cycle-life of a lithium rechargeable battery.

A high-strength polymer such as polyamideimide or polyimide may have strong tensile strength and binding stress surrounding the active material, but applies binding strength to the active material with a current collector (a copper current collector). The strong binding strength of the active material to the current collector causes the expansion of the current collector since the volume expansion of the active material may occur slightly during the charge, even though the high-strength polymer suppress the volume expansion of the active material. The expanded copper current collector is not shrunk during the discharge, while the negative electrode is shrunk with shrinkage of the active material, and thus, transforms the current collector. The transformed current collector severely deteriorates cycle-life characteristic of a rechargeable lithium battery and easily brings about its safety problem.

According to one embodiment of the present invention, a negative electrode for a rechargeable lithium battery includes an active material layer including a non-carbon-based negative active material, and a first binder having high-strength; a conductive layer including a conductive material and a second binder; and a current collector. The conductive layer is interposed between the active material layer and the current collector.

The first binder having high-strength may increase binding strength of the active material layer with the current collector in a negative electrode. Accordingly, the expanded negative electrode may play a role of elongating the current collector.

Specifically, the first binder having high-strength applies high tensile strength and binding stress to the negative active material severely causing the aforementioned volume expansion of the negative electrode and thus, may suppress the volume expansion.

The first binder having high-strength may not only apply strong binding stress to the negative active material but also have bigger binding strength between negative active material layer and negative electrode than polyvinylidene fluoride or a styrene butadiene rubber commonly used for a rechargeable lithium battery.

The first binder having high-strength may include an engineering polymer having high heat resistance and any well-known oligomer-shaped binder used to improve dissolving property of the engineering polymer without any particular limit and for example, polyimide, polyamideimide, polysulfone, polyphenylenesulfide, polyetherimide, polyethersulfone, polyarylate, polyetheretherketone, modified polyimide, and the like or a combination thereof, but the present invention is not limited thereto.

In the active material layer, the mixing ratio of the non-carbon-based negative active material and the first binder having a high-strength may be about 70:30 wt % to 99:1 wt %. When the mixing ratio fallen into the above range, the active material layer may be able to obtain more sufficient adhesion to exhibit cycle-life characteristics, and its energy density may be improved, although its resistance may not increase.

The active material layer may further include a general conductive material. If the active material layer further includes a general conductive material, the general conductive material refers to the second conductive material, and the conductive material in the conductive layer refers to the first conductive material. The second conductive material may be selected from a carbon-based material, a metal-based material, a conductive polymer, and a combination thereof. An amount of the second conductive material may be about 0.1 wt % to about 20 wt % based on the weight of the active material layer.

The negative electrode for a rechargeable lithium battery includes a conductive layer and may weaken binding strength between the active material layer and the current collector and thus, suppress detachment or transformation of the current collector due to expansion and shrinkage of an electrode (corresponding to the active material layer). The active material layer and the current collector are expanded together during the charge, but the current collector is not shrunk with the active material layer during the discharge but detached and transformed. Herein, when the current collector directly contacts with the first binder having heat resistance, the current collector is closely attached to the active material layer and more severely detached and transformed. The conductive layer may prevent directly strong attachment of the active material layer to the current collector and thus, weaken binding strength of the current collector with the active material layer and improve detachment and transformation of the current collector.

The second binder may be well-known binder materials without limitation, and may be for example, polyvinylalcohol, polyacrylic acid, poly acrylamide, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

In one embodiment, the second binder may be poly pyrrole-based, poly aniline-based, poly acetylene-based, poly thiophene-based conductive polymer.

The conductive material may be selected from a carbon-based material, a metal-based material, a conductive polymer, and a combination thereof. The carbon-based material may be capable of intercalating and deintercalating lithium or incapable of intercalating and deintercalating lithium. The carbon-based material may include natural graphite, artificial graphite, a vapor grown carbon fiber (VGCF), carbon black, acetylene black, ketjen black, a carbon fiber, graphene, carbon nanotube, and the like, or may be a mixture thereof.

Examples of the metal-based material may include a metal powder or a metal fiber including copper, nickel, aluminum, silver, and the like; examples of the conductive polymer may include a polyphenylene derivative, and the like; or a mixture thereof.

The conductive material may be a mixture of a carbon-based material that can intercalates and deintercalates lithium and thus functions as an active material, and an electron conductive material that provides an electrode with conductivity but does not function as an active material.

In the conductive layer, the mixing ratio of the conductive material and the second binder may be 10:90 wt % to 70:30 wt %. When the mixing ratio falls into the above range, the conductive layer may obtain more sufficient conductivity between the active material layer and the current collector, and there may be more improved adherence between the active material layer and the current collector.

The non-carbon-based negative active material is a material being capable of doping and dedoping lithium. Examples include lithium metal, a lithium metal alloy, Si, SiOₓ (0<x<2), a Si—C composite, a Si-Q alloy (wherein Q is an alkali metal, an alkaline-earth metal, Group 13 to 16 elements, a transition element, a rare earth element, or a combination thereof, but not Si), Sn, SnO₂, a Sn—C composite, a Sn—R alloy (wherein R is an alkali metal, an alkaline-earth metal, Group 13 to 16 elements, a transition element, a rare earth element, or a combination thereof, but not Sn), a transition element oxide, or a combination thereof. Examples of the lithium metal alloy include lithium and a metal selected from Na, K, Rb, Cs, Fr, Be, Mg, Ca, Sr, Si, Sb, Pb, In, Zn, Ba, Ra, Ge, Al, or Sn. The elements Q and R may be selected from Fe, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. Examples of the transition metal oxide include vanadium oxide, lithium vanadium oxide, and the like.

The negative electrode for a rechargeable lithium battery includes a negative active material having a high volume expansion rate during the charge and may effectively solve a current collector detachment or transformation problem due to the negative active material. In general, a metal-based negative active material such as Si, Sn, or the like is required to solve this volume expansion problem. Accordingly, in one embodiment, the negative active material may be Si, SiOₓ (0<x<2), a Si—C composite, a Si-Q alloy (wherein Q is an alkali metal, an alkaline-earth metal, Group 13 to 16 elements, a transition element, a rare earth element, or a combination thereof, but not Si), Sn, SnO₂, a Sn—C composite, a Sn—R alloy (wherein R is an alkali metal, an alkaline-earth metal, Group 13 to 16 elements, a transition element, a rare earth element, or a combination thereof, but not Sn), or a combination thereof.

The non-carbon-based negative active material may have a volume expansion rate of greater than or equal to about 30% during the formation charge.

In another embodiment, the metal-based negative active material may include at least about 20 wt % of a Si atom based on the total weight of a negative active material. The negative active material may include about 30 wt % to about 100 wt % of a Si atom based on the total weight of a negative active material.

According to another embodiment of the present invention, provided is a rechargeable lithium battery that includes the negative electrode for a rechargeable lithium battery; a positive electrode including a positive active material; and an electrolyte.

In general, a rechargeable lithium battery may be classified as a lithium ion battery, a lithium ion polymer battery, and a lithium polymer battery according to the presence of a separator and the kind of an electrolyte used therein. The rechargeable lithium battery may have a variety of shapes and sizes and thus, may include a cylindrical, prismatic, coin, or pouch-type battery and a thin film type or a bulky type in size. The structure and fabricating method for a lithium ion battery pertaining to the present invention are well known in the art.

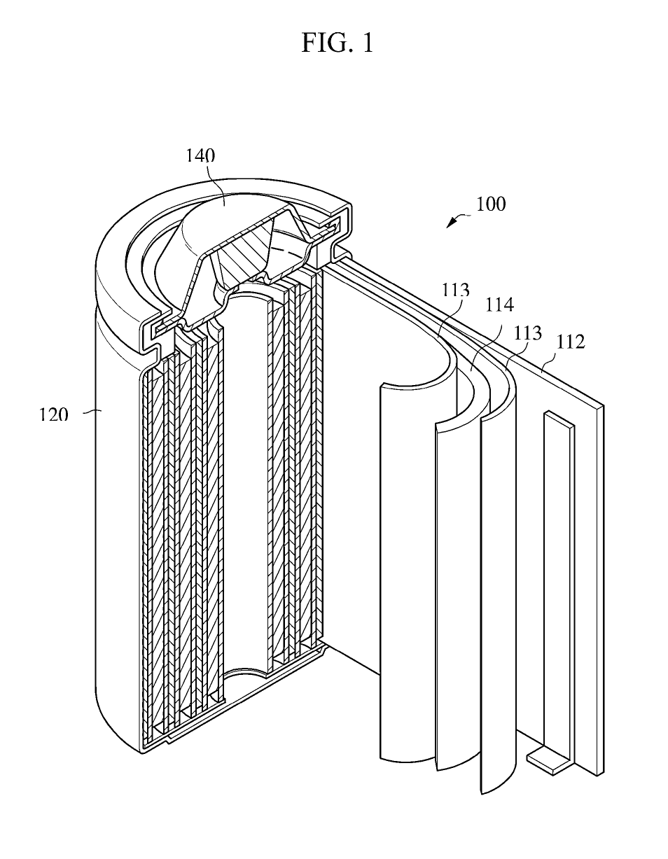

FIG. 1 is an exploded oblique view showing a schematic structure of a rechargeable lithium battery constructed as an embodiment of the present invention. Referring to FIG. 1, the rechargeable lithium battery 100 is a cylindrical battery that includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The rechargeable lithium battery 100 is fabricated by sequentially laminating a negative electrode 112, a positive electrode 114, and a separator 113, spirally winding them, and housing the spirally-wound product in a battery case 120.

The negative electrode is the same as described above.

The current collector of the negative electrode includes a copper foil, a nickel foil, a stainless steel foil, a titanium foil, a nickel foam, a copper foam, a polymer substrate coated with a conductive metal, or combinations thereof.

The positive electrode may include a current collector and a positive active material layer formed on the current collector.

The positive active material includes a lithiated intercalation compound that reversibly intercalates and deintercalates lithium ions. The positive active material may include a composite oxide including at least one selected from the group consisting of cobalt, manganese, and nickel, as well as lithium. Specific examples may be the compounds represented by the following chemical formulae:

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above Chemical Formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The positive active material may be a compound with the coating layer on the surface or a mixture of the active material and a compound with the coating layer thereon. The coating layer may include at least one coating element compound selected from the group consisting of an oxide of the coating element and a hydroxide of the coating element, an oxyhydroxide of the coating element, an oxycarbonate of the coating element, and a hydroxycarbonate of the coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any contemporary processes unless it causes any side effects on the properties of the positive active material (e.g., spray coating, immersing), which is well known to those who have ordinary skill in this art and will not be illustrated in detail.

The positive active material layer further includes a binder and a conductive material.

The binder improves binding properties of the positive active material particles to one another and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidenefluoride, polyethylene, polypropylene, a styrene-butadiene rubber, an acrylated styrene-butadiene rubber, an epoxy resin, nylon, and the like but are not limited thereto.

The conductive material improves electrical conductivity of a positive electrode. Any electrically conductive material can be used as a conductive agent unless it causes a chemical change. Examples of the conductive material include at least one selected from natural graphite, artificial graphite, carbon black, acetylene black, ketjen black, a carbon fiber, a metal powder or a metal fiber including copper, nickel, aluminum, silver, and the like. A conductive material such as a polyphenylene derivative and the like may be mixed.

The current collector may be Al but is not limited thereto.

The negative and positive electrodes may be manufactured in a method of preparing an active material composition by mixing the active material, a conductive material, and a binder and coating the composition on a current collector. The electrode manufacturing method is well known and thus, is not described in detail in the present specification. The solvent includes N-methylpyrrolidone and the like but is not limited thereto.

The electrolyte may include a non-aqueous organic solvent and a lithium salt.

The non-aqueous organic solvent plays a role of transmitting ions taking part in the electrochemical reaction of a battery.

The non-aqueous organic solvent may include a carbonate-based, ester-based, ether-based, ketone-based, alcohol-based, or aprotic solvent. The carbonate-based solvent may include dimethylcarbonate (DMC), diethylcarbonate (DEC), dipropylcarbonate (DPC), methylpropylcarbonate (MPC), ethylpropylcarbonate (EPC), ethylmethylcarbonate (EMC), ethylenecarbonate (EC), propylenecarbonate (PC), butylenecarbonate (BC), and the like. The ester-based solvent may include methyl acetate, ethyl acetate, n-propyl acetate, 1,1-dimethylethyl acetate, methylpropinonate, ethylpropinonate, γ-butyrolactone, decanolide, valerolactone, mevalonolactone, caprolactone, and the like. The ether-based solvent may include dimethyl ether, dibutyl ether, tetraglyme, diglyme, dimethoxyethane, 2-methyltetrahydrofuran, tetrahydrofuran (THF), and the like. The ketone-based solvent may include cyclohexanone, and the like. The alcohol-based solvent may include ethanol, isopropylalcohol, and the like. The aprotic solvent include nitriles such as R—CN (wherein R is a C2 to C20 linear, branched, or cyclic hydrocarbon, and may include one or more double bonds, one or more aromatic rings, or one or more ether bonds), amides such as dimethylformamide, dimethylacetamide, dioxolanes such as 1,3-dioxolane, sulfolanes, and the like.

The non-aqueous organic solvent may be used singularly or in a mixture. When the organic solvent is used in a mixture, its mixture ratio can be controlled in accordance with desirable performance of a battery.

The carbonate-based solvent may include a mixture of a cyclic carbonate and a linear carbonate. The cyclic carbonate and the linear carbonate are mixed together in a volume ratio of about 1:1 to about 1:9 as an electrolyte, the electrolyte may have enhanced performance.

In addition, the electrolyte of the present invention may be prepared by further adding the aromatic hydrocarbon-based solvent to the carbonate-based solvent. The carbonate-based solvent and the aromatic hydrocarbon-based solvent are mixed together in a volume ratio of about 1:1 to about 30:1.

The aromatic hydrocarbon-based organic solvent may be represented by the following Chemical Formula 1.

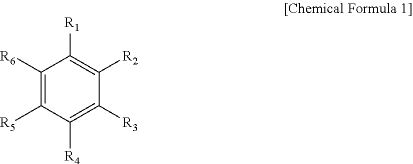

In Chemical Formula 1, R₁ to R₆ are each independently hydrogen, halogen, a C1 to C10 alkyl group, a C1 to C10 haloalkyl group, or a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate or an ethylene carbonate-based compound represented by the following Chemical Formula 2 in order to improve cycle-life of a battery.

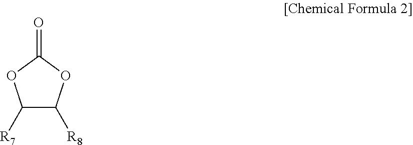

In Chemical Formula 2, R₇ and R₈ are each independently hydrogen, a halogen, a cyano group (CN), a nitro group (NO₂) or a C1 to C5 fluoroalkyl group, provided that at least one of R₇ and R₈ is a halogen, a cyano group (CN), a nitro group (NO₂) or a C1 to C5 fluoroalkyl group

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and combinations thereof. The use amount of the vinylene carbonate or the ethylene carbonate-based compound for improving cycle life may be adjusted within an appropriate range.

The lithium salt is dissolved in the non-aqueous solvent and supplies lithium ions in a rechargeable lithium battery, and basically operates the rechargeable lithium battery and improves lithium ion transfer between positive and negative electrodes. The lithium salt include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, LiB(C₂O₄)₂ (lithium bis(oxalato) borate, LiBOB), and a combination thereof. The lithium salt may be used in a concentration of about 0.1 to about 2.0M. When the lithium salt is included within the above concentration range, it may electrolyte performance and lithium ion mobility due to optimal electrolyte conductivity and viscosity.

The separator 113 may include any materials commonly used in the lithium battery as long as separating a negative electrode 112 from a positive electrode 114 and providing a transporting passage of lithium ion. In other words, it may have a low resistance to ion transport and an excellent impregnation for electrolyte solution. For example, it may be selected from glass fiber, polyester, TEFLON (tetrafluoroethylne), polyethylene, polypropylene, polytetrafluoroethylene (PTFE), or a combination thereof. It may have a form of a non-woven fabric or a woven fabric. For example, for the lithium ion battery, polyolefin-based polymer separator such as polyethylene, polypropylene or the like is mainly used. In order to ensure the heat resistance or mechanical strength, a coated separator including a ceramic component or a polymer material may be used. Selectively, it may have a mono-layered or multi-layered structure.

The following examples illustrate the present invention in more detail. These examples, however, should not in any sense be interpreted as limiting the scope of the present invention.

### EXAMPLES

### Example 1

### Negative Electrode

A 1 μm-thick conductive layer was formed by mixing 4.3 g of acetylene black and 43 g (10 wt % of a solid) of a polyvinylidene fluoride (PVDF) solution (solvent: N-methylpyrrolidone) with a ball mill and then, coating the mixture on a copper (Cu) current collector and drying it. Then, 22.5 g of a Si—Ti—Fe alloy active material (Si 54 wt %, Ti 22 wt %, Fe 24 wt %), 0.5 g of acetylene black, and 10 g (20 wt % of a solid) of a polyimide solution (solvent: N-methylpyrrolidone) were mixed in N-methylpyrrolidone to prepare a negative active material slurry. The slurry was coated and dried on the copper current collector having the conductive layer, fabricating a negative electrode.

### Positive Electrode

A positive electrode was fabricated by mixing a LiCoO₂ positive active material, a polyvinylidene fluoride binder, and a carbon black (super-P) conductive material in a weight ratio of 96:2:2 in N-methylpyrrolidone to prepare positive active material slurry and then, coating, drying, and compressing the positive active material slurry on an aluminum foil current collector.

### Electrolyte Solution

An electrolyte was prepared by uniformly mixing 60 volume % of dimethyl carbonate as a linear carbonate-base solvent, 30 volume % of ethylene carbonate (EC) as a cyclic carbonate-based solvent, and 10 volume % of fluoroethylene carbonate (FEC) and dissolving LiPF₆ in 1.0 M of a concentration.

The negative and positive electrodes and the electrolyte solution were used to fabricate a 2032 coin cell. The coin cell was measured regarding cycle-life characteristic up to 50th cycle. Another 2032 coin cell fabricated in the same way was formation-charged (0.05 C charge for once) and first-charged at 0.5 C for once and decomposed to check transformation of the copper current collector.

The coin cell had good cycle-life characteristic and much improved transformation of the copper current collector.

### Example 2

A 2032 coin cell was fabricated according to the same method as Example 1 except for using a mixture of 4.0 g of acetylene black and 0.3 g of carbon nanotube (CNT) instead of the conductive agent for the conductive layer in Example 1.

### Example 3

A 2032 coin cell was fabricated according to the same method as Example 1 except for using an aqueous polyvinylalcohol (PVA) binder instead of PVDF as the second binder for the conductive layer.

### Example 4

A 2032 coin cell was fabricated according to the same method as Example 1 except for using modified polyimide having solubility to water instead of polyimide having solubility to N-methylpyrrolidone as the first binder for the negative active material layer, and using water instead of N-methylpyrrolidone for the negative active material slurry.

### Example 5

A 2032 coin cell was fabricated according to the same method as Example 1 except for using 10 g of a Si—Ti—Fe alloy active material, 12.5 g of graphite, 0.5 g of acetylene black, 10 g (20 wt % of a solid) of a polyimide solution to prepare a negative active material slurry for the negative active material layer.

### Example 6

A 2032 coin cell was fabricated according to the same method as Example 1 except for using a silicon oxide (SiOₓ, 0≦x<2) active material instead of a Si alloy-based active material to prepare a negative active material slurry for the negative active material layer.

### Example 7

A 2032 coin cell was fabricated according to the same method as Example 1 except for using 10 g of a Si metal and 12.5 g of graphite instead of the Si alloy active material to prepare a negative active material slurry for the negative active material layer.

### Comparative Example 1

A negative active material slurry was prepared by mixing 22.5 g of a Si—Ti—Fe alloy active material, 0.5 g of acetylene black, and 10 g (20 wt % of a solid) of a polyimide solution (solvent: N-methylpyrrolidone). This slurry was coated and dried on a 10 μm-thick copper current collector, fabricating a negative electrode.

The negative electrode was used with a positive electrode and an electrolyte fabricated in the same method as Example 1 to fabricate a 2032 coin cell. The 2032 coin cell was checked regarding cycle-life characteristic up to 50 cycles. Another 2032 coin cell fabricated in the same way as above was formation-charged and first-charged at 0.5 C and decomposed to check transformation of a copper current collector.

The 2032 coin cell had good cycle-life characteristic but much transformation of the copper current collector.

### Comparative Example 2

A negative active material slurry was fabricated by mixing 22.5 g of a Si—Ti—Fe alloy active material, 1.5 g of acetylene black, and 5 g (20 wt % of a solid) of a polyimide solution in order to weaken binding strength by increasing a conductive material component having a large surface area. The slurry was coated and dried on a 10 μm-thick copper current collector, fabricating a negative electrode. The negative electrode was used with a positive electrode and an electrolyte solution prepared in the same method as Example 1 to fabricate a 2032 coin cell.

The 2032 coin cell was measured regarding cycle-life characteristic up to 50 cycles. Another 2032 coin cell fabricated in the same method as aforementioned was formation-charged and first-charged at 0.5 C and decomposed to check transformation of a copper current collector.

The coin cell had relatively improved transformation of a copper current collector but much deteriorated cycle-life characteristic.

### Comparative Example 3

A negative active material slurry was prepared by mixing 23.5 g of a Si—Ti—Fe alloy active material, 0.5 g of acetylene black, and 5 g (20% of a solid) of a polyimide solution in order to weaken binding strength by decreasing the amount of a binder. The slurry was coated and dried on a 10 μm-thick copper current collector, fabricating a negative electrode.

The negative electrode was used with a positive electrode and an electrolyte solution prepared according to the same method as Example 1 to fabricate a 2032 coin cell. The 2032 coin cell was measured regarding cycle-life characteristic up to 50 cycles. Another 2032 coin cell fabricated according to the same method as Example 1 was formation-charged and first-charged at 0.5 C and decomposed to check transformation of a copper current collector.

The con cell had relatively-deteriorated cycle-life characteristic but not improved current collector transformation.

### Comparative Example 4

A negative active material slurry was prepared by mixing 22.5 g of a Si—Ti—Fe alloy active material, 0.5 g of acetylene black, 9 g (20% of a solid) of a polyimide solution, and 1 g (20% of a solid) of a poly pyrrole-based conductive binder solution in order to weaken binding strength by using a binder having small binding strength. The slurry was coated and dried on a 10 μm-thick copper current collector, fabricating a negative electrode.

The negative electrode was used with a positive electrode and an electrolyte solution prepared in the same method as Example 1 to fabricate a 2032 coin cell. The 2032 coin cell was measured regarding cycle-life characteristic up to 50 cycles. Another 2032 coin cell fabricated in the same method as above was formation-charged and first-charged at 0.5 C and decomposed to check transformation of a copper current collector.

The coin cell had relatively-deteriorated cycle-life characteristic but not much improved current collector transformation.

### Comparative Example 5

A polyvinylidene fluoride solution (20 wt % of a solid) was coated on a Cu current collector to form a polymer layer with a thickness of a less than or equal to 1 μm-thick polymer layer. Then, a negative active material slurry was prepared by mixing 22.5 g of a Si—Ti—Fe alloy active material, 0.5 g of acetylene black, and 10 g (20 wt % of a solid) of a polyimide solution. The slurry was coated and dried on the copper current collector having the polymer layer, fabricating a negative electrode.

The negative electrode was used with a positive electrode and an electrolyte solution prepared in the same method as Example 1 to fabricate a 2032 coin cell. The 2032 coin cell was measured regarding cycle-life characteristic up to 50 cycles. Another 2032 coin cell fabricated in the same method as above was formation-charged and first-charged at 0.5 C and decomposed to check transformation of a copper current collector.

The coin cell had improved current collector transformation but relatively-deteriorated cycle-life characteristic.

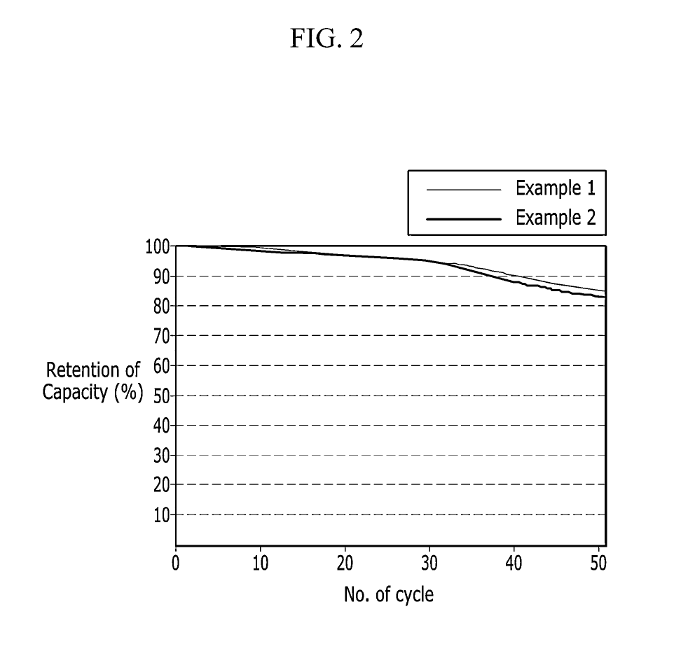

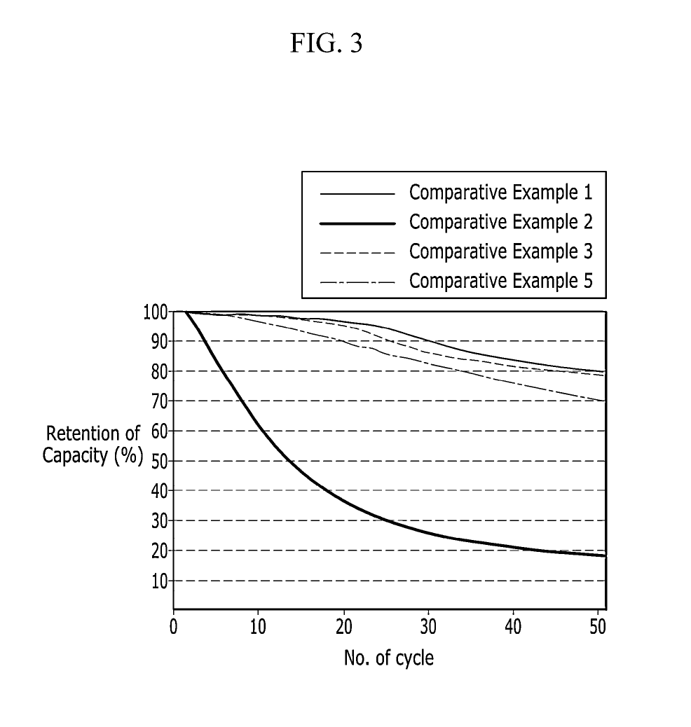

FIG. 2 is a diagram showing cycle-life characteristic results of the rechargeable lithium battery cells according to Examples 1 and 2, and FIG. 3 is a diagram showing cycle-life characteristic results of the rechargeable lithium battery cells according to Comparative Examples 1, 2, 3 and 5.

As shown in FIGS. 2 and 3, the battery cells of Examples 1 and 2 had better cycle number characteristic than the ones according to Comparative Examples 1, 2 and 5.

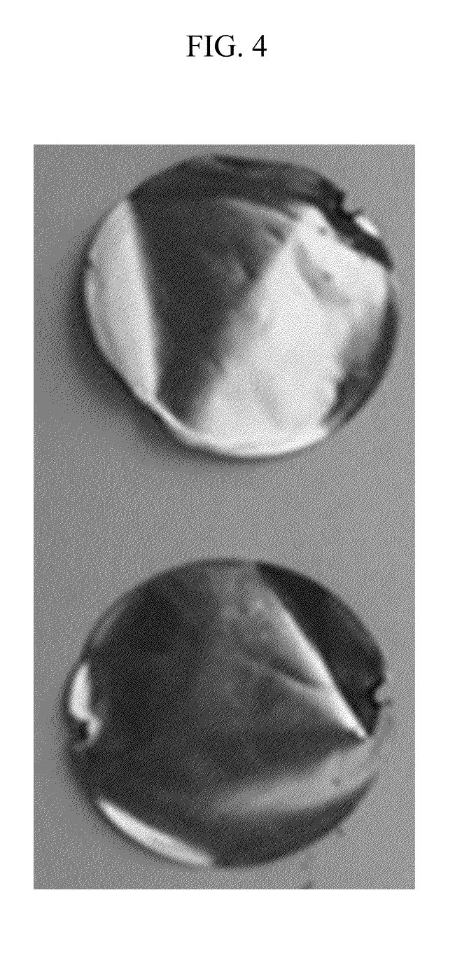

Two cells were fabricated according to Example 1 and were first charged at 0.5 C. The cells were then disassembled, thereby obtaining two copper current collectors, in order to evaluate the transformation of the copper current collectors. Two photographs regarding the resulting copper current collectors are shown in FIG. 4.

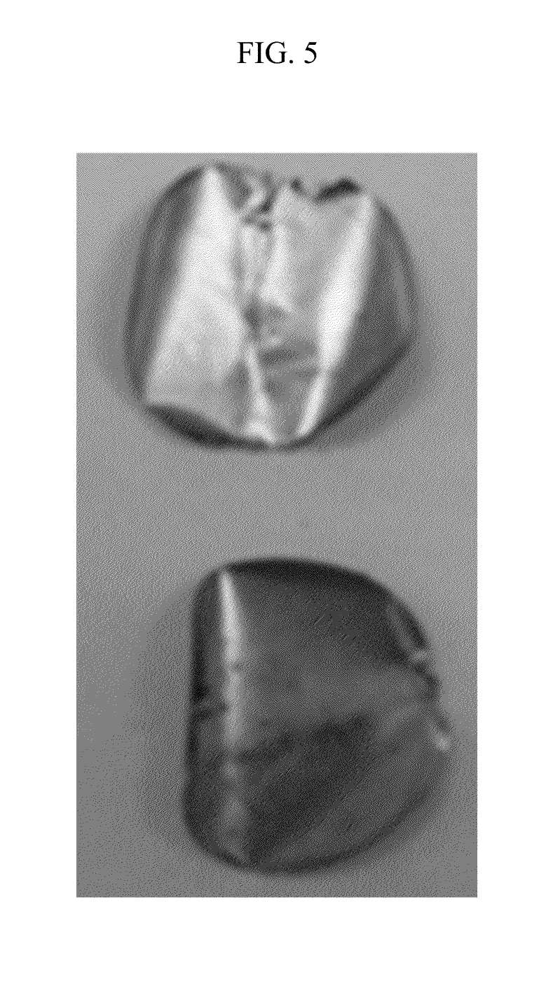

Two cells were fabricated according to Example 2 and were first charged at 0.5 C. The cells were then disassembled, thereby obtaining two copper current collectors, in order to evaluate the transformation of the copper current collectors. Two photographs regarding the resulting copper current collectors are shown in FIG. 5.

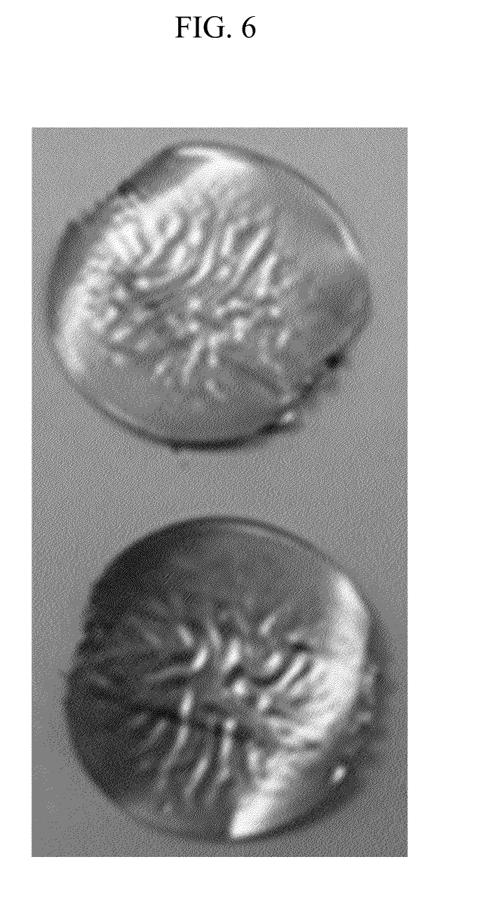

Two cells were fabricated according to Comparative Example 1 and were first charged at 0.5 C. The cells were then disassembled, thereby obtaining two copper current collectors, in order to evaluate the transformation of the copper current collectors. Two photographs regarding the resulting copper current collectors are shown in FIG. 6.

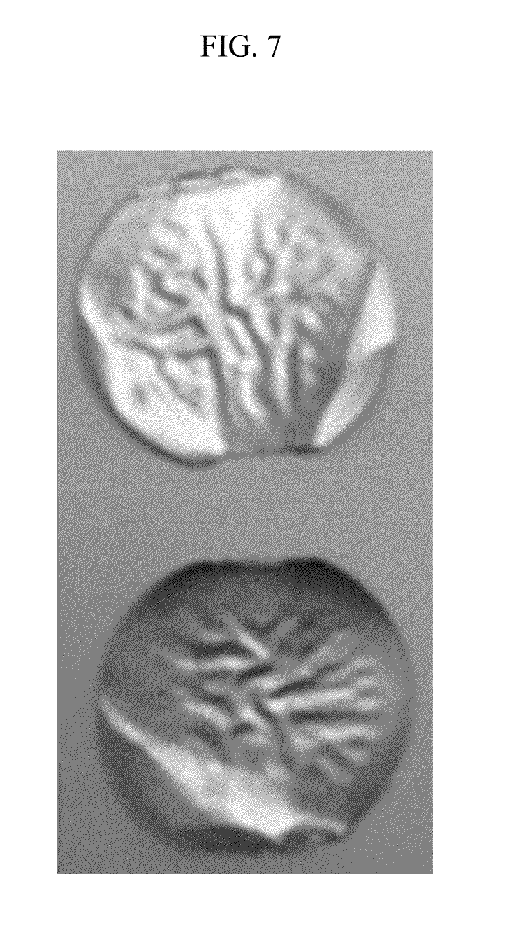

Two cells were fabricated according to Comparative Example 4 and were first charged at 0.5 C. The cells were then disassembled, thereby obtaining two copper current collectors, in order to evaluate the transformation of the copper current collectors. Two photographs regarding the resulting copper current collectors are shown in FIG. 7.

The copper current collector according to Examples 1 and 2 had improved transformation like a wrinkle in the center.

The current collectors according to Examples 1 to 7 and Comparative Examples 1 to 5 were examined about wrinkles due to current collector expansion and measured regarding cycle-life characteristic. The results are provided in the following Table 1.

<Evaluation Reference of Substrate Expansion>

∘: no wrinkle produced due to current collector expansion.

Δ: a few wrinkles

x: plenty of wrinkles

<Evaluation Reference of Cycle-Life Characteristic>

∘: maintain greater than or equal to about 75% of initial cycle capacity after 50 cycles.

Δ: maintain initial cycle capacity of greater than or equal to about 50% to less than 75% after 50 cycles.

x: maintain initial cycle capacity of less than about 50% after 50 cycles.

TABLE 1

| | Amount (wt %) of Si | | |
|---|---|---|---|
| | atom of negative active | Wrinkle according | |
| | material layer (based on | to expansion | Cycle-life |
| | 100 wt % of negative | of current | character- |
| | active material) | collector | istic |
| Example1 | 51.8 | ∘ | ∘ |
| Example2 | 51.8 | ∘ | ∘ |
| Example3 | 51.8 | ∘ | ∘ |
| Example4 | 51.8 | ∘ | ∘ |
| Example5 | 23.0 | ∘ | ∘ |
| Example6 | 57.3 | ∘ | ∘ |
| Example7 | 40.0 | ∘ | ∘ |
| Comparative | 51.8 | x | ∘ |
| Example1 | | | |
| Comparative | 51.8 | Δ | x |
| Example2 | | | |
| Comparative | 54.1 | x | Δ |
| Example3 | | | |
| Comparative | 51.8 | x | Δ |
| Example4 | | | |
| Comparative | 51.8 | ∘ | Δ |
| Example5 | | | |

Embodiments of the present invention provide a negative electrode which has a conductive layer including a conductive material and a second binder. The conductive layer is interposed between an active material and a current collector of the negative electrode. The negative electrode may improve cycle-life of a rechargeable lithium battery and alleviate current collector transformation problem.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A negative electrode for a rechargeable lithium battery, comprising:
an active material layer including a non-carbon-based negative active material, and a first binder having high-strength;
a conductive layer including a conductive material and a second binder; and
a current collector, and
the conductive layer interposed between the active material layer and the current collector.

2. The negative electrode for a rechargeable lithium battery of claim 1, wherein the first binder having high-strength is at least one selected from polyimide, polyamideimide, polysulfone, polyphenylenesulfide, polyetherimide, polyethersulfone, polyarylate, polyetheretherketone, modified polyimide, and a combination thereof.

3. The negative electrode for a rechargeable lithium battery of claim 1, wherein the second binder is selected from polyvinylalcohol, polyacrylic acid, poly acrylamide, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and a combination thereof.

4. The negative electrode for a rechargeable lithium battery of claim 1, wherein the conductive material is a carbon-based material.

5. The negative electrode for a rechargeable lithium battery of claim 4, wherein the conductive material is a carbon-based material being incapable of intercalating and deintercalating lithium.

6. The negative electrode for a rechargeable lithium battery of claim 4, wherein the conductive material is a mixture of a carbon-based material being capable of intercalating and deintercalating lithium.

7. The negative electrode for a rechargeable lithium battery of claim 1, wherein the non-carbon-based negative active material is selected from a lithium metal, a lithium metal alloy, Si, SiOₓ (0<x<2), a Si—C composite, a Si-Q alloy (wherein Q is an element selected from an alkali metal, an alkaline-earth metal, Group 13 to 16 elements, a transition element, a rare earth element, or a combination thereof, but is not Si), Sn, SnO₂, a Sn—C composite, a Sn—R alloy (wherein R is an alkali metal, an alkaline-earth metal, Group 13 to 16 elements, a transition element, a rare earth element, or a combination thereof, but not Sn), a transition element oxide, and a combination thereof.

8. The negative electrode for a rechargeable lithium battery of claim 7, wherein the non-carbon-based negative active material comprises at least about 20 wt % of a Si atom based on the total weight of a negative active material.

9. The negative electrode for a rechargeable lithium battery of claim 1, wherein the active material layer further comprises a carbon-based negative active material as well as the non-carbon-based negative active material.

10. The negative electrode for a rechargeable lithium battery of claim 1, wherein the conductive material is included as a first conductive material, and the active material layer further comprises a second conductive material.

11. The negative electrode for a rechargeable lithium battery of claim 10, wherein the second conductive material is selected from a carbon-based material, a metal-based material, a conductive polymer, and a combination thereof.

12. A rechargeable lithium battery, comprising:
the negative electrode for a rechargeable lithium battery of claim 1;
a positive electrode including a positive active material; and
an electrolyte.
